(19) United States
(12) Patent Application Publication
(10) Pub. No.: US 2010/0145789 A1
(43) Pub. Date: Jun. 10, 2010

(54) APPARATUS, METHOD AND SYSTEM FOR LOADING DIGITAL TRANSACTION DOCUMENTS TO A PERSONAL DIGITAL DEVICE

(75) Inventors: Srinivasa Upadhya, San Francisco, CA (US); Mayank Bhatnagar, Fremont, CA (US)

Correspondence Address: Clise, Billion & Cyr, P.A., 605 U.S. Highway 169, Suite 300, Plymouth, MN, 55441, US

(73) Assignee: ECRIO, INC., Cupertino, CA (US)

(21) Appl. No.: 12/635,469

(22) Filed: Dec. 10, 2009

Related U.S. Application Data
(60) Provisional application No. 61/201,448, filed on Dec. 10, 2008.

(51) Int. Cl. G06Q 30/00; G06F 15/16; G06K 7/10

(52) U.S. Cl. 705/14.38; 709/204; 235/462.01

(57) ABSTRACT

In a system for providing digital transaction documents to a personal digital device for digital barcode redemption at retail, a browser-enabled personal digital device or a hosted personal digital device (“hosted PDD”) may be used. In the latter instance, the host illustratively is a personal computer running any suitable web browser, and the hosted PDD is connected to the host in any suitable manner. The web browser is connected to the Internet in any suitable manner, along with a profile server and a promotions server. The web browser includes a browser-based plug-in object or webdriver, which operates independently within the web browser to load to the personal digital device digital transaction documents pushed directly by the promotions server or indirectly by the profile server via the Internet. The load operations are transparent to the user of the personal digital device. The profile server may have content management tools to enable the user to manage content, or the webdriver may have additional functionality to enable management of content. The personal digital device may be used at a point-of-sale to present any of the digital transaction documents by transmitting a pulsed beam of light to a barcode scanner.

### CROSS-REFERENCE TO RELATED APPLICATIONS

This application claims the benefit of U.S. Provisional Patent Application Ser. No. 61/201,448 filed Dec. 10, 2008, which hereby is incorporated herein in its entirety by reference thereto.

### BACKGROUND OF THE INVENTION

1. Field of the Invention

This invention relates to management of digital transaction documents, and more particularly to apparatus, methods and systems for loading digital transaction documents to a personal digital device and optionally for managing the digital transaction documents on the personal digital device.

2. Description of the Related Art

A variety of small mobile digital devices that use MoBeam® technology to transmit information to standard point-of-sale (“POS”) barcode scanners are available from Ecrio Inc. of Cupertino, Calif., USA, and are described in one or more of the following patents: U.S. Pat. No. 6,685,093 issued Feb. 3, 2004 to Challa et al.; U.S. Pat. No. 6,877,665 issued Apr. 12, 2005 to Challa et al.; U.S. Pat. No. 7,028,906 issued Apr. 18, 2006 to Challa et al.; and U.S. Pat. No. 7,395,961 issued Jul. 8, 2008 to Challa et al. The Mobeam technology involves the beaming of pulsed light to barcode scanners to simulate the long-and-short sequencing of a standard barcode. The pulsed light is interpreted by the barcode scanners as a reflection from a printed paper barcode.

A particularly suitable application for devices enabled with the MoBeam technology is submission of digital transaction documents at points-of-sale via barcode scanners. Small, lightweight and simple handheld devices including fob-type devices in particular offer an extremely satisfying user experience at the point-of-sale because of their simplicity and convenient shape, size and weight of the device, and the speed, reliability, and ease-of-use of the MoBeam technology for presenting barcodes to barcode scanners.

The digital transaction documents may be any type of information that one may wish to communicate while at a facility equipped with a bar code scanner, including information conventionally communicated using bar codes, as well as other types of information that are not conventionally communicated using bar codes because of, for example, physical limitations imposed by the bar code format.

While digital transaction documents may be placed on digital devices enabled with the MoBeam technology in many different ways, one of the most attractive ways is for the device to receive the barcode information from over the Internet. For coupon applications, for example, the device may be used to store requested offers. For ticketing applications, for example, the device may be used to store an event ticket purchased online. For customer loyalty and incentive programs, the device may be used to store registration information during online registration. For contests and drawings, the device may be used to store entry forms.

It is desirable to use a computer such as a personal computer connected to the Internet to load content from a remote location such as a server or web site to the digital device enabled with the MoBeam technology. For this purpose, the device may be provided with wired or wireless connectivity, such as a universal serial bus (“USB”) connector for connection to a personal computer. The use of USB for connection to personal computers is commonplace, and many other types of simple devices such as MP3 players connect to a personal computer using either a USB cable or a USB connector mounted on the device itself. Commonly, an executable application is loaded on the personal computer to handle the load and management operations.

FIG. 1 shows an example of an executable application running on a personal computer and implementing pull technology for loading content to a media player. A media player 18 is connected to a personal computer 14 by a USB cable. A media management application 17 running on the personal computer 14 has access to a media server 10 over the Internet 12. The personal computer 14 also includes a web browser 15 for conventional web browsing functions. Interacting with the media management application 17, a user selects content for loading to the media player 18 and initiates the transfer. The media management application 17 requests the desired content from the media server 10 via the Internet 12, in effect “pulling” the content from the media server 10. The content is stored on the personal computer 14 in a database 16, from which it is loaded to the media player 18. Examples of the executable application 16, media player 18, and the media server 10 include, for example, the iTunes® application program, the iPod® mobile digital device, and the iTunes store, which are available from Apple Inc. of Cupertino, Calif., USA.

### BRIEF SUMMARY OF THE INVENTION

Personal digital devices (“PDD”) using the MoBeam® technology available from Ecrio Inc. of Cupertino, Calif., USA, to transmit information to standard point-of-sale (“POS”) barcode scanners offer an satisfying user experience at the point-of-sale because of the speed, reliability, and ease-of-use of the MoBeam technology. These devices generally can be used for digital barcode redemption at retail. A particular type of personal digital device, the MoBeam® key (previously known as the ClipPod™ device) available from Ecrio Inc. of Cupertino, Calif., USA, is a small, lightweight, simple and inexpensive electronic device that is particularly useful for this purpose. Advantageously, the MoBeam key uses the MoBeam technology to transmit electronically stores barcodes and other digital transaction documents to standard POS barcode scanners, and enhances the user experience at the POS because of the simplicity and convenient shape, size and weight of the device. It is a hosted PDD, meaning that the loading and optionally management of digital transaction documents is done with the MoBeam key connected to a host. While the description herein regarding loading and management of digital transaction documents focuses on the MoBeam key, it is equally applicable to personal digital devices generally, whether hosted or not, and whether incorporating the MoBeam technology or not.

Digital transaction documents may be any type of information that one may wish to communicate to enable a digital transaction. One illustrative type of digital transaction is the delivery of a promotion to a viewer over a set top box, personal computer, or any other type of interactive entertainment device, and the purchase of the promoted product by the viewer using an interactive feature of the interactive entertainment device. Another illustrative type of digital transaction is the presentation of a digital transaction document while at a facility equipped with a bar code scanner, where the digital transaction document may have information conventionally communicated using bar codes, as well as other types of information that are not conventionally communicated using bar codes because of, for example, physical limitations imposed by the bar code format. Digital transaction documents include, for example, numeric, alphabetic, or alphanumeric data, an index, or other data values. Digital transaction documents represent, for example, boarding pass information, e-ticket information, ticket information, credit card information, debit card information, automated teller machine card information, identification information, account information, electronic payment information, wire transfer information, purchase information, security information, affinity information, shopping lists, coupons, gift cards, customer loyalty and incentive program information, and contest information. For coupon applications using the MoBeam key, for example, the customer may “beam” a barcode representing a manufacturer's or retailer's offer to a laser scanner at the point of sale, to apply the discount at checkout. For ticketing applications, for example, the attendee may “beam” a barcode representing a ticket for an event such as a movie or sports event on demand to a laser scanner at the event site entrance. For customer loyalty and incentive programs, for example, rather than carrying a stack of bulky plastic cards, the customer may “beam” barcodes representing her account information to laser scanners at the checkstand. For contests and drawings, for example, retailers looking to increase traffic in their locations can distribute to shoppers barcodes representing promotions and entries in contests. The shoppers can then “beam” the barcodes to laser scanners when visit the retailers' stores to enter the contests and drawings for special prizes.

Due to its simplicity, the MoBeam key lacks access to digital transaction documents over sophisticated wireless networks such as Wi-Fi and cellular networks. One technique for placing digital transaction documents on the MoBeam key involves connecting the MoBeam key to a personal computer, and running an executable application on the personal computer to handle digital transaction document download and management under shopper control. Unfortunately, executable applications running on personal computers present complexities that are inconsistent with the satisfying user experience offered by the MoBeam key at the point-of-sale.

One of the problems encountered with the approach of using an executable application running on the personal computer, set top box, or other type of personal digital device is the necessity to explicitly install the application. If the application is downloaded and installed from a remote location, this involves interrupting the shopper's web browsing experience to perform the installation process. If the application is installed from other media like CD-ROM or DVD, there is an assumption that the appropriate media hardware and resources (CD-ROM/DVD drive etc.) are available on the shopper's computer.

Another problem encountered with this approach is the addition of clutter to the shopper's computer. Most shoppers have many applications installed on their computers. By installing yet another application with its associated resources such as icons, Start-Menu items, shortcuts, and the like, the user experience is often affected negatively. In extreme cases, merely locating the correct application to use with a device can be time-consuming and frustrating.

Another problem encountered with this approach is the use of the “pull” model to acquire content. In order to download new content from a location remote to the device, the content is stored on the shopper's computer so that the application can perform the download to the device. Since the remote location has no knowledge of the location of the application, the application itself requests (“pulls”) content from the remote location, stores and manages it locally (in RAM, ROM or on the file system), and then provides it to the device.

Another problem encountered with this approach is the necessity to periodically check for updates in order to obtain bug-fixes and added application functionality: The application vendor has no knowledge of all the shoppers who have installed the application. Without this knowledge, the vendor cannot notify shoppers if or when upgrades are available for bug-fixes or additional functionality. Shoppers who encounter incorrect behavior in the application may choose to avoid using the application entirely instead of contacting the vendor, reducing overall value for all parties.

Another problem encountered with this approach is the necessity to manually upgrade or reinstall the application if a newer or upgraded device is used. If the shopper chooses to purchase a newer or upgraded device, it is quite possible that the application may also need to be upgraded. Problems associated with explicitly upgrading/reinstalling the application are mentioned above.

Another problem encountered with this approach is the implicit necessity to encapsulate a large amount of functionality (code/features) in the application in order to support a rich user experience. If the actual content that is stored on the device is rich or complex, this implies that the application is fully capable of processing the content and presenting it in a human-understandable form. This in turn implies that the size (in kilobytes) of the application may be large and occupy significant disk space on the shopper's computer.

Another problem encountered with this approach is security, encryption and protection. Since the application is installed on the computer, hackers with malicious intentions can reverse-engineering the application and obtain the algorithms used to store and manage content on the device. This can lead to a number of problems including: storing malicious/incorrect content on the device; spoofing of devices; ability to circumvent security (or identify security loopholes) when communicating with a remote location using the ‘pull’ model, and gain access to unauthorized information; possible violations of IP pertaining to the use of proprietary algorithms; and the ability to circumvent any DRM technologies that are used in the solution.

Another problem encountered with this approach is the inability to provide a seamless web browsing and content loading experience. With an application that is installed on the shopper's computer, the experience by which the shopper browses for content online and downloads it to a device that is connected to their computer is neither seamless nor simple.

Digital transaction documents may be supported on personal digital devices. Personal digital devices that are also mobile and incorporate the MoBeam technology offer an extremely satisfying user experience at a point-of-sale because of their convenient shape, size and weight, and the speed, reliability, and ease-of-use of the MoBeam technology for presenting barcodes to barcode scanners. Some hosted PDD's such as the MoBeam key have additional advantages, such as extremely light weight, variable form factor, low cost, and simplicity. It is desirable to provide users, including shoppers, with an equally satisfying experience when managing content on personal digital devices, as well as when using a personal computer or other host to load content to hosted PDD's such as the MoBeam key. Each of the embodiments of the invention claimed and described herein solves one or more of the various problems identified above.

One embodiment of the present invention is a method for loading digital transaction documents to a personal digital device, comprising providing a browser-based plug in object from the personal digital device to a host for installation on a host for a web browser operating on the host; and receiving on the personal digital device, via the browser-based plug in object operating on the host, digital transaction documents pushed from a server.

Another embodiment of the present invention is a browser-based plug in object for operating on a host, comprising a program element for installing the browser-based plug in object from a personal digital device on the host for a web browser operating on the host; a program element for establishing a shopper profile on a profile server, the host being networked to the profile server; and a program element for loading digital transaction documents pushed from a server to the personal digital device in accordance with the shopper profile via the browser-based plug in object; wherein the browser-based plug in object operates independently of the browser and transparently to a user of the host during the loading step.

Another embodiment of the present invention is a method for managing and loading digital transaction documents to a MoBeam key, comprising installing a browser-based plug in object on a host for a web browser operating on the host; establishing a shopper profile on a profile server, the host being networked to the profile server; connecting the MoBeam key into a host; and loading digital transaction documents pushed to the MoBeam key in accordance with the shopper profile via the browser-based plug in object; wherein the browser-based plug in object operates independently of the browser and transparently to a user of the host during the loading step.

Another embodiment of the present invention is a network for managing and loading digital transaction documents to a MoBeam key, comprising a profile server comprising a shopper profile; a promotions server comprising digital transaction documents; a host comprising a web browser operating on the host and a browser-based plug in object running under the browser; a MoBeam key removably connected to the host; and a network for interconnecting the host, the profile server and the promotions server; wherein the browser-based plug in object is adapted to operate independently of the browser and transparently to a user of the host for loading digital transaction documents originating with the promotions server and pushed to the MoBeam key.

Another embodiment of the present invention is a method for loading digital transaction documents to a personal digital device, comprising running a web browser; instantiating a browser-based plug-in object in the web browser for receiving from over a network a plurality of digital transaction documents and loading the digital transaction documents received in the receiving step to a memory of the personal digital device, and communicating at least one of the digital transaction documents from the memory of the personal digital device to enable a digital transaction.

Another embodiment of the present invention is a mobile personal digital device comprising a processor; a memory associated with the processor; a network communications system controlled by the processor; a web browser computer program element; and a browser-based plug-in object for receiving with the network communications system from over a network a plurality of digital transaction documents and loading the digital transaction documents received in the receiving step to the memory; and a computer program element for communicating at least one of the digital transaction documents from the memory of the personal digital device to enable a digital transaction.

Another embodiment of the present invention is a computer-readable medium encoded with a browser-based plug-in object comprising attributes and behaviors for receiving from over a network a plurality of digital transaction documents; and loading the digital transaction documents received in the receiving step to a memory of the personal digital device.

### BRIEF DESCRIPTION OF THE SEVERAL VIEWS OF THE DRAWINGS

FIG. 1 is a schematic diagram of a prior art system for providing media content to a media player.

FIG. 2 through FIG. 6 are plan views of various types of MoBeam keys.

FIG. 7 is a schematic diagram of a system for providing digital transaction documents to a MoBeam key, for transmission to a barcode reader.

FIG. 8 is a schematic diagram of a system for providing digital transaction documents to a personal digital device, for transmission to a barcode reader.

FIG. 9 is a schematic diagram of a system for providing digital transaction documents from a personal digital device to a barcode reader.

FIG. 10 is a schematic flow diagram of a system for managing and loading digital transaction documents to a MoBeam key, for transmission to a barcode reader.

FIG. 11 is a schematic flow diagram of another system for managing and loading digital transaction documents to a MoBeam key, for transmission to a barcode reader.

FIG. 12 is a schematic flow diagram of another system for managing and loading digital transaction documents to a MoBeam key, for transmission to a barcode reader.

FIG. 13 is a schematic flow diagram of another system for managing and loading digital transaction documents to a MoBeam key, for transmission to a barcode reader.

FIG. 14 is a flow diagram of a method for providing digital transaction documents as light pulses to a barcode reader.

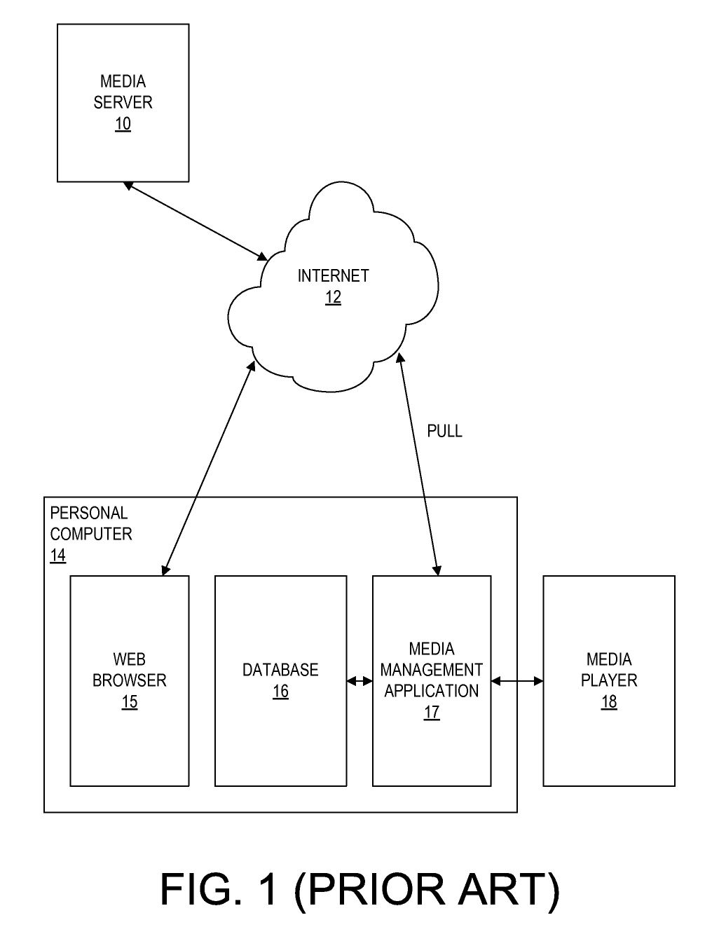

### DETAILED DESCRIPTION OF THE INVENTION, INCLUDING THE BEST MODE

The technique described herein facilitates the dissemination of digital transaction documents to personal digital devices, including personal digital devices capable of transmitting information to barcode scanners using the MoBeam® technology, and in some implementations, to small, lightweight, simple and inexpensive electronic devices such as the MoBeam® key available from Ecrio Inc. of Cupertino, Calif., USA.

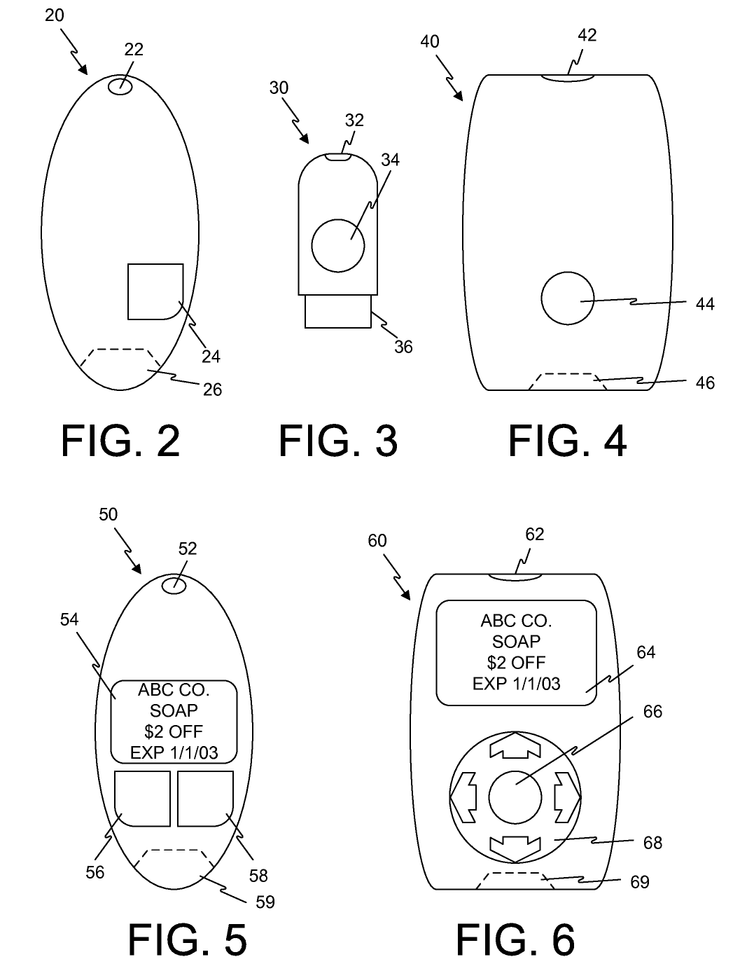

FIG. 2 through FIG. 6 show various examples of MoBeam key-type devices. FIG. 2 shows a very simple device 20 of an oval configuration that has a light source 22, an activation button 24, and a USB connector 26. FIG. 3 shows a very simple device 30 of a USB stick configuration that has a light source 32, an activation button 34, and a built-in USB plug 36. FIG. 4 shows a very simple device 40 of a rectangular configuration that has a light source 42, an activation button 44, and a USB connector 46. FIG. 5 shows a device 50 of a oval configuration that has a light source 52, a display screen 54, navigation and select buttons 56 and 58, and a USB connector 59. FIG. 6 shows a device 60 of a rectangular configuration that has a light source 62, a display screen 64, a select button 66, a navigation disk 68, and a USB connector 69.

Devices such as 50 and 60 which include display screens (54 and 64 respectively) and navigation controls (56/58 and 68 respectively) provide users of the devices, illustratively shoppers, with the ability to scroll through individual data codes to find the particular transaction document that the shopper wishes to transmit to a particular barcode scanner. Thus, such devices may store multiple different pieces of information, such as coupons, admission tickets, credit card information, and so forth, which may be selected and transmitted to one or more barcode scanners at different times, as desired by the shopper. The display screens also may be used to display product views or other representative images, and even static visual images of barcodes to enable reading by scanners such as charge coupled device (CCD) scanners.

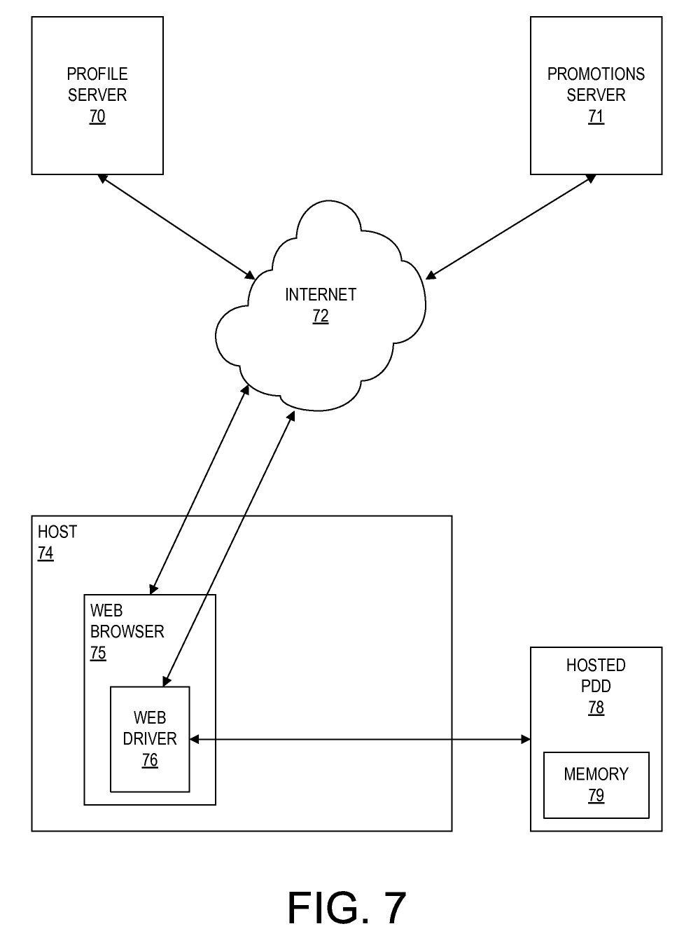

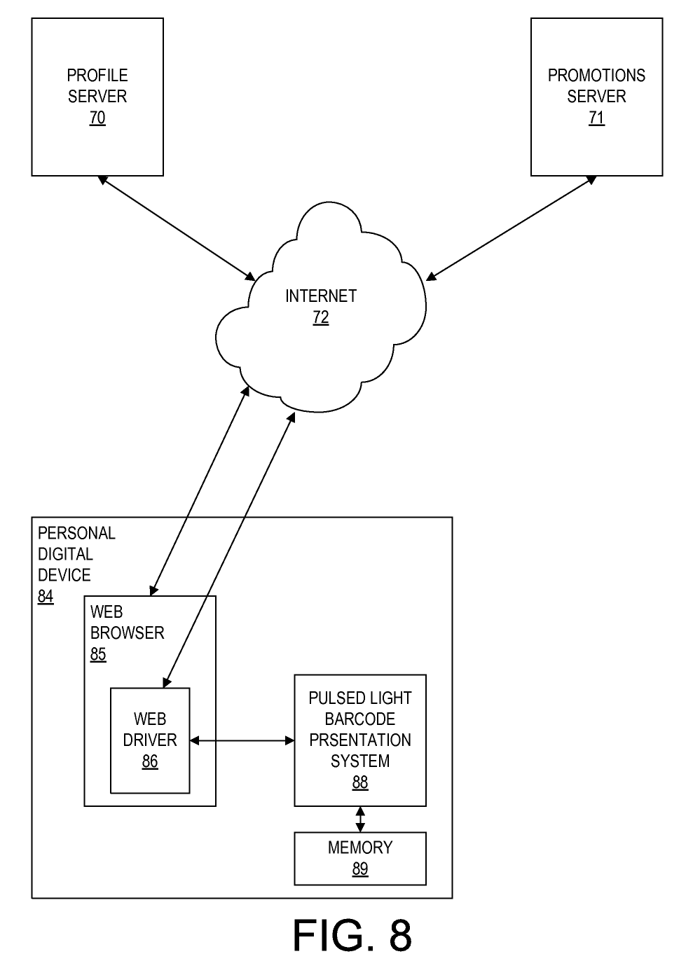

FIGS. 7 and 8 show illustrative systems for providing digital transaction documents to personal digital devices. FIG. 7 shows an illustrative system for providing digital transaction documents to a hosted PDD 78 with a memory 79, such as a MoBeam key, for digital barcode redemption at retail. The hosted PDD 78 is connected to a local host 74 in any suitable manner. Removable wired connections such as USB and wireless connections such as Bluetooth are suitable. The host 74 illustratively is a personal computer running any suitable web browser 75, such as the Windows® Internet Explorer® web browser available from Microsoft Corporation of Redmond, Wash., USA, the Firefox® web browser available from the Mozilla Foundation of Mountain View, Calif., USA, or the Safari™ web browser available from Apple Inc. of Cupertino, Calif., USA. Alternatively, any device having access to the internet using a web browser may be used as a host, including, for example, mobile digital devices such as the iPhone™ mobile digital device and the various Windows Mobile® phones, set top boxes, televisions with built-in internet access, and gaming consoles with internet access. A digital transaction document server such as, illustratively, a promotions server 71, and the web browser 75 are connected to the internet 72 in any suitable manner, illustratively in accordance with the HTTP protocol. The web browser 75 includes a browser-based plug-in object or webdriver 76, which operates independently within the web browser 75 to load to the hosted PDD 78 digital transaction documents from the promotions server 71 via the Internet 72. Database storage of the digital transaction documents on the host 74 is not needed, although temporary storage in cache memory (not shown) may be used to provide data flow control. The load operations are transparent to the user of the host 74, illustratively a shopper. The webdriver 76 may be provided with additional functionality if desired, such as the capability to manage content on the hosted PDD 78.

FIG. 8 shows an illustrative system for providing digital transaction documents to a personal digital device 84 that runs any suitable web browser 85 and incorporates a permanently connected and fully integrated pulsed light barcode presentation system 88 having access to memory 89. Mobile personal digital devices such as the iPhone™ mobile digital device and the various Windows Mobile® OS phones and Android OS phones are particularly suitable. Suitable web browsers 85 include standard and mobile versions of the Windows® Internet Explorer® web browser available from Microsoft Corporation of Redmond, Wash., USA, the Firefox® web browser available from the Mozilla Foundation of Mountain View, Calif., USA, the Chrome browser available from Google Inc. of Mountain View, Calif., USA, or the Safari™ web browser available from Apple Inc. of Cupertino, Calif., USA. The pulsed light barcode presentation system 88 may be based on the MoBeam technology, for example. The web browser 85 includes a browser-based plug-in object or webdriver 86, which operates independently within the web browser 85 to load digital transaction documents to memory of the personal digital device 84 from the promotions server 71 via the Internet 72. The load operations are transparent to the user of the personal digital device, illustratively a shopper. The webdriver 86 may be provided with additional functionality if desired, such as the capability to manage content on the personal digital device 84.

Although the server 71 shown in FIGS. 7 and 8 is a promotions server for providing digital promotion material such as coupons, customer loyalty and incentive program information, and contest information, a transaction document server may be used instead to provide any type of digital transaction document. Moreover, digital transaction documents, including digital promotional material, may be provided by any number of separate servers that are connected to the internet in any suitable manner.

The profile server 70 provides content management tools to enable a shopper to manage content on the hosted PDD 78 or on the personal digital device 84. The shopper can review and select content using a variety of different criteria, ranging from specific product promotions to geographical areas of interest and the type of digital transaction documents desired. The profile server 70 and the promotions server 71 may be separate servers or integrated into a single server. The profile server 70 is connected to the internet in any suitable manner, illustratively in accordance with the HTTP protocol.

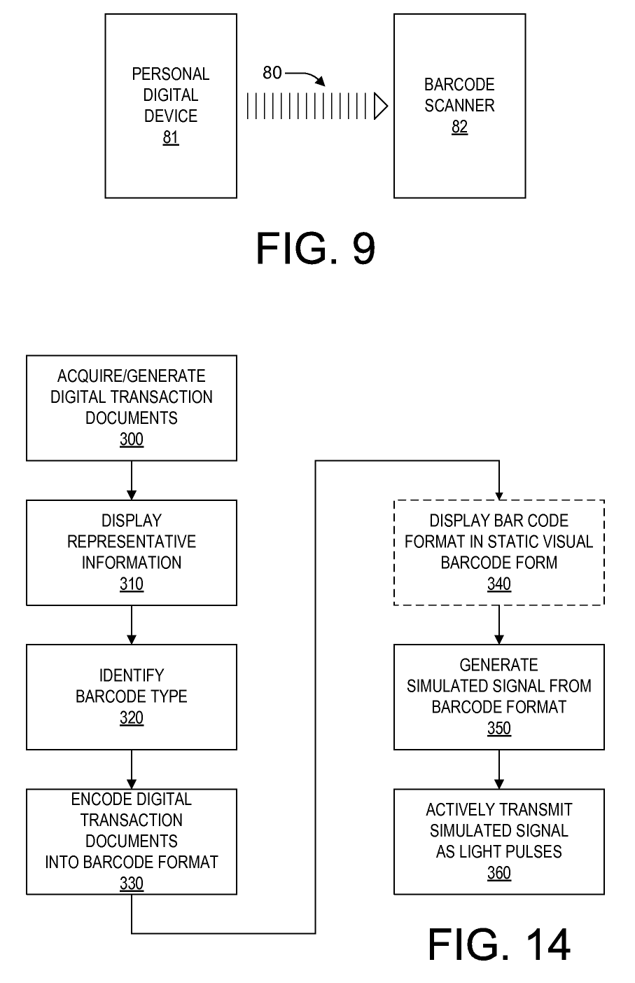

FIG. 9 shows a personal digital device 81 such as the hosted PDD 78 or the personal digital device 84 in use at a POS for digital barcode redemption at retail. In the case of the hosted PDD 78 (FIG. 7), the shopper disconnects the hosted PDD 78 from the host 74, carries the personal digital device to a point-of-sale, and at her convenience redeems promotions by transmitting a pulsed beam of light 80 from the hosted PDD 78 to a barcode scanner 82, based on data in the memory of the hosted PDD 78. In the case of the personal digital device 84 (FIG. 8), the shopper simply has the personal digital device with her at a point-of-sale, and redeems promotions by transmitting a pulsed beam of light 80 from the personal digital device 84 to a barcode scanner 82, based on data in the memory of the personal digital device 84. The pulsed beam of light 80 simulates the long-and-short sequencing of preferably a standard barcode representative of the digital transaction documents from the promotions server 71.

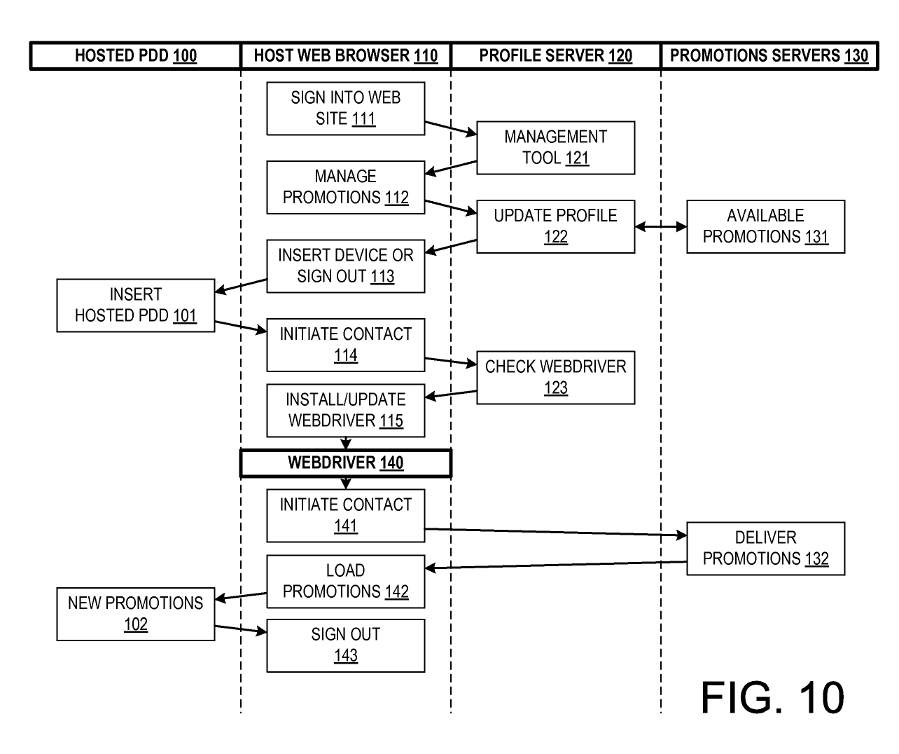

FIGS. 10-13 show alternative webdriver implementations which have in common numerous advantages over executable applications. One advantage in some implementations is elimination of the need to explicitly install the application. The webdriver 76 or 86 may be installed as part of the shopper's browsing actions when the shopper visits a relevant web site for the first time, illustratively the profile server 70, or in the case of webdriver 76, when the shopper connects a personal digital device such as the hosted PDD 78 to the host 74. The installation is non-invasive and transparent to the shopper, and does not impact the user experience.

Another advantage of the webdrivers 76 and 86 in some implementations is avoidance of clutter to the host 74. Since it is not a standalone application running on the host 74, the webdrivers 76 and 86 create none of the clutter associated with traditional applications.

The webdrivers 76 and 86 may be compliant with either a “pull” model or a “push” model for the digital transaction documents. Advantageously, compliance with a push model provides enhanced security.

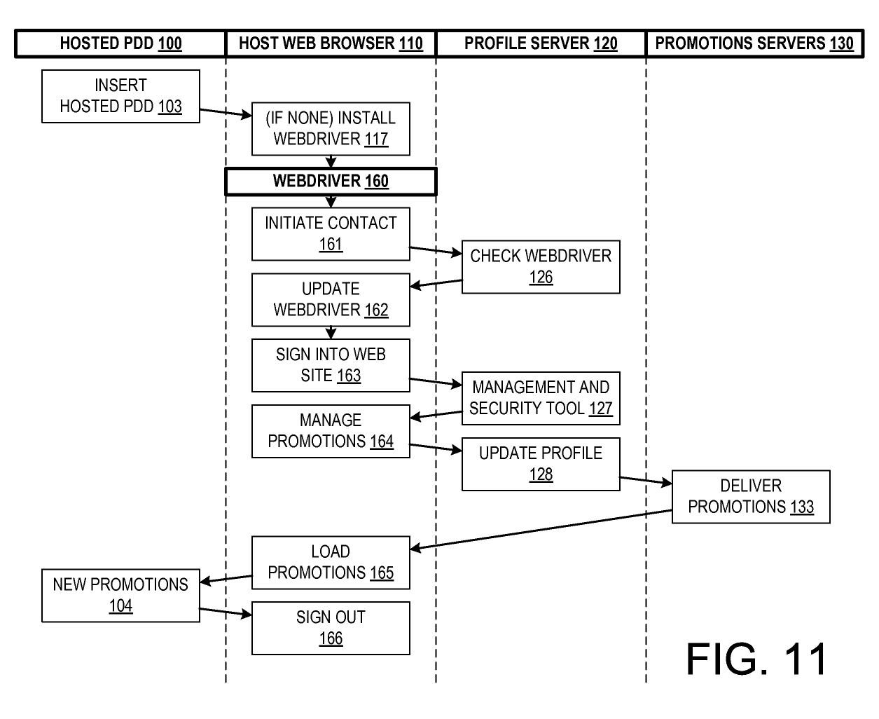

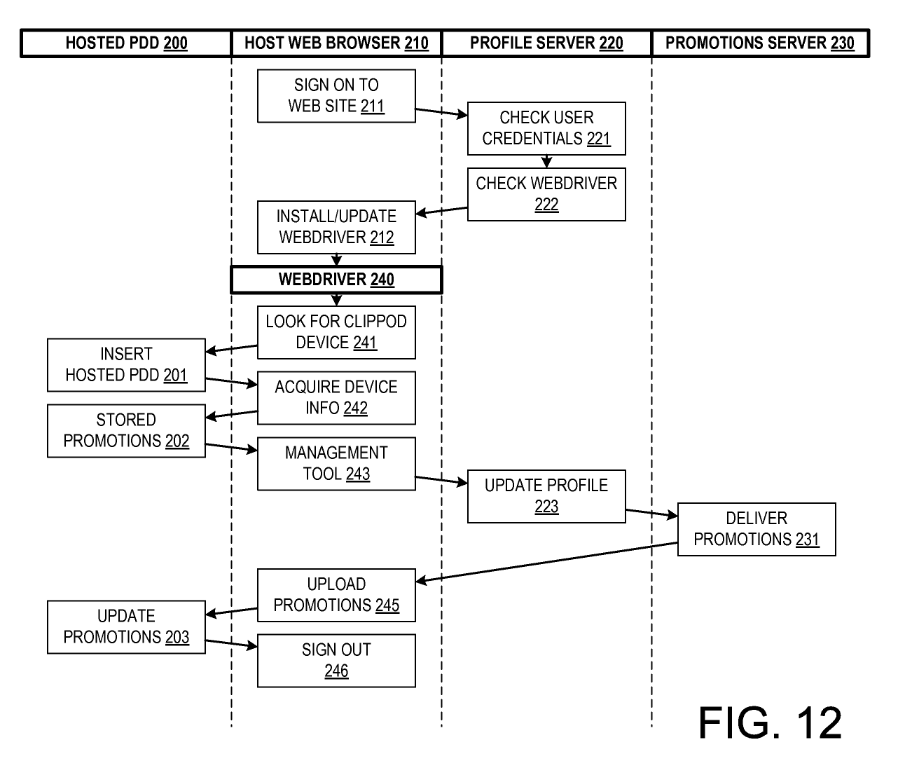

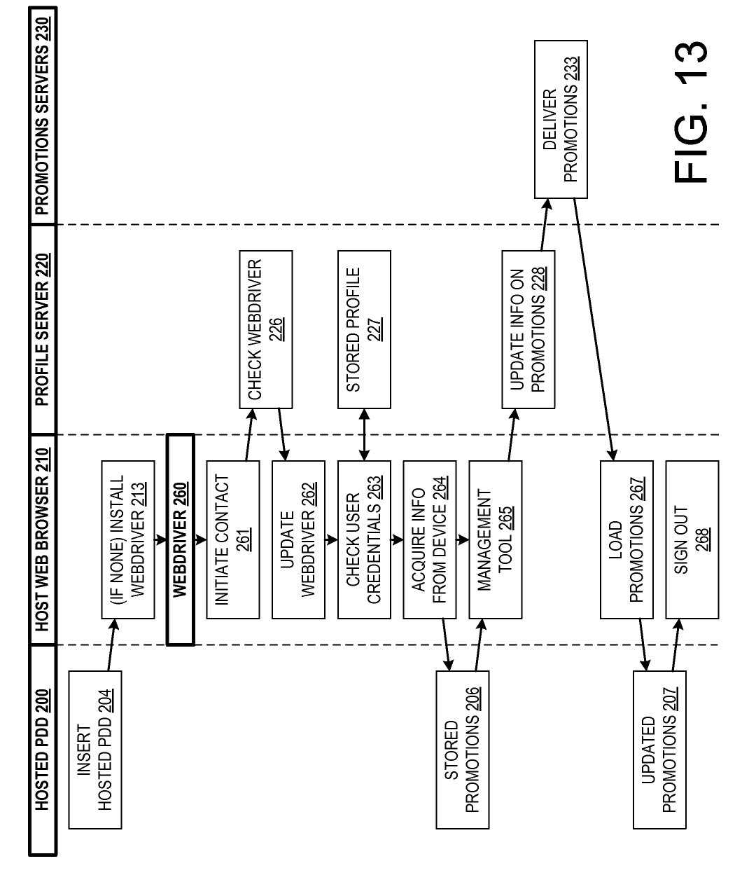

In some implementations the webdrivers 76 and 86 need not encapsulate a large amount of functionality (code/features) in order to support a rich user experience. If the shopper wishes to load new content, the shopper specifies the desired content using the program resources of the profile server 70, which in one type of implementation is accessed using the basic functionality of the browser (see FIGS. 10 and 11), and in another type of implementation is accessed at least in part using customized functionality of the webdriver (see FIGS. 12 and 13). In other words, the management function is mostly implemented on the profile server 70 in the FIGS. 10 and 11 implementations, while the management function is divided between the profile server 70 and the webdrivers 76 and 86 in the FIGS. 12 and 13 implementations. In either event, when the digital transaction documents desired are specified and the hosted PDD 78 is connected to the host 74, the desired digital transaction documents are loaded to the hosted PDD 78 via the webdriver 76, or to the personal digital device 84 via the web driver 86, in accordance with the shopper's profile, with the desired digital transaction documents originally residing either at the promotions server 71 or at a consolidation server (which may be separately implemented or implemented along with the profile server 70).

Another advantage of the webdrivers 76 and 86 in some implementations is elimination of any need to periodically check for updates in order to obtain bug-fixes and added application functionality. The webdrivers 76 and 86 may be activated from a web site, illustratively the profile server 70, or in the case of the webdriver 76 when the hosted PDD 78 is connected to the host 74. The profile server 70 then checks if the webdriver 76 or 86 is current, and if the webdriver is not current, automatically initiates the upgrade process without user intervention and without interrupting the shopper's browsing experience.

Another advantage of the webdrivers 76 and 86 in some implementations is elimination of any need to manually upgrade or reinstall the application if a newer or upgraded device is used. Various characteristics of a connected device may be automatically detected by the web site, illustratively the profile server 70, when the shopper visits the web site. If a newer device is identified, the web site may automatically initiate a modification of the webdriver 76 or 86 in a non-invasive fashion to handle the new device.

Another advantage of the webdrivers 76 and 86 in some implementations is elimination of any need to encapsulate a large amount of functionality (code or features) in the application in order to support a rich user experience. All or at least most of the processing of content, including selection, updating, management, and load, may be performed on the servers that host the web site, illustratively the profile server 70 and the promotions server 71. This allows the webdrivers 76 and 86 to be implemented if desired as an extremely ‘thin’ object that serves as a conduit between the web site and the device, with minimal impact on the shopper's computer.

Another advantage of the webdrivers 76 and 86 in some implementations is security. Since most if not all processing of content occurs on the web site servers, illustratively the profile server 70 and the promotions server 71, the essential functionality is hidden from hackers who penetrate the security of the host 74 or the personal digital device 84.

Another advantage of the webdrivers 76 and 86 in some implementations is providing the shopper with a seamless web browsing and loading experience. When the shopper visits a web site, the web site may automatically detect that a device is connected to the shopper's computer, may retrieve content information from the connected device, may display the content information to the shopper, may empower the shopper to manage the content and select new content, and may update the content on the device. The web site allows the shopper to seamlessly browse and select new content, and update the device accordingly.

FIG. 10 shows an illustrative implementation in which a host web browser 110 is used to access a profile server 120 for managing digital transaction documents, illustratively promotions, on a hosted PDD 100 such as a MoBeam key. Using the host web browser 110, a shopper signs on to the profile server 120 on the digital transaction documents management website (block 111). Following a credentials check, the profile server 120 provides a management tool page (block 121), which the shopper uses to manage the promotions on the hosted PDD 100 using the shopper's profile stored on the profile server (block 112). Based on the options selected by the shopper, the shopper's profile on the profile server 120 is updated (block 122) consistent with the digital transaction documents (illustratively promotions) available from a promotions server 130 (block 131). The shopper is then invited to insert the hosted PDD 100 into the host, or to sign off for later loading of the digital transaction documents.

If the shopper inserts the hosted PDD 100 (block 101), the host web browser 110 initiates contact with the profile server 120 (block 114) which then checks if a webdriver is installed and if the installed version is the current version (block 123). If necessary, the webdriver 140 is installed or updated (block 115) and then initiates contact with the promotions server 130 (block 141) to request delivery of available digital transaction documents (illustratively promotions) from the promotions server 130 in accordance with the updated shopper's profile (block 132). The requested digital transaction documents (illustratively promotions) are loaded via the webdriver 140 (block 142) to the hosted PDD 100 (block 102). The webdriver 140 may pull the digital transaction documents (illustratively promotions) from the promotions server 130, or the promotions server 130 may push the digital transaction documents (illustratively promotions) to the webdriver 140, as desired. The shopper signs out when the transfer of new promotions to the hosted PDD 100 is completed (block 143).

FIG. 11 shows another illustrative implementation in which a host web browser 110 is used to access a profile server 120 for managing digital transaction documents, illustratively promotions, on illustratively a hosted PDD 100. A webdriver 160 is used which, like the webdriver 140 in the FIG. 10 implementation, has relatively simple functionality and therefore may be an extremely thin object. Unlike the FIG. 10 implementation, in the FIG. 11 implementation, the browser-based plug-in object for the webdriver 140 is provided to the host by the hosted PDD. In particular, a program element in the hosted PDD 100 may install the browser-based plug-in object on the host from the hosted PDD 100 for the web browser operating on the host. The FIG. 10 and FIG. 11 implementations may be combined, if desired.

As shown in FIG. 11, the shopper may insert the hosted PDD 100 into the host (block 103), whereupon a loader program detects if the webdriver 160 is missing and if so, installs the webdriver 160 browser-based plug-in (block 117). The webdriver 160 initiates contact with the profile server 120 (block 161) which then checks whether the installed webdriver is the current version (block 126). If necessary, the webdriver 160 is updated (block 162) and initiates a secure sign-in procedure with the profile server 120 (block 163). The profile server 120 provides a management and security tool page (block 126), which the shopper uses to sign-in and manage the promotions on the hosted PDD 100 using the shopper's profile stored on the profile server (block 127). Based on the options selected by the shopper (block 164), the shopper's profile on the profile server 120 is updated (block 128) consistent with the digital transaction documents (illustratively promotions) available from the promotions server 130, and delivery is requested of the available digital transaction documents (illustratively promotions) from the promotions server 130 in accordance with the updated shopper's profile (block 133). The requested digital transaction documents (illustratively promotions) are loaded via the webdriver 160 (block 165) to the hosted PDD 100 (block 104). The webdriver 160 may pull the digital transaction documents (illustratively promotions) from the promotions server 130, or the promotions server 130 may push the digital transaction documents (illustratively promotions) to the webdriver 160, as desired. The shopper signs out when the transfer of new promotions to the hosted PDD 100 is completed (block 166).

FIG. 12 shows an illustrative implementation in which a webdriver 240 running in a host web browser 210 is provided with additional functionality for controlling digital transaction document (illustratively promotions) management. Using the host web browser 210, a shopper signs on to the profile server 220 on the digital transaction documents management website (block 211). Following a credentials check (block 221), the profile server 220 checks if a webdriver is installed and if the installed version is the current version (block 222). If necessary, the webdriver 240 is installed or updated (block 212).

The webdriver 240 then requests insertion of the hosted PDD 200 and monitors for the insertion (block 241). When the hosted PDD 200 is inserted (block 201), the webdriver 240 collects information from the hosted PDD 200 about the digital transaction documents (illustratively promotions) stored in device memory (blocks 242 and 202). The webdriver 240 provides the shopper with a management tool (bock 243) which enables the shopper to check the current content of the hosted PDD 200, to remove undesired and expired digital transaction documents (illustratively promotions), to explore what new promotion material is available, and to select new digital transaction documents (illustratively promotions). The user's profile the profile server 220 is updated accordingly, and requests are made for digital transaction documents (illustratively promotions) in accordance with the updated user's profile. The requested digital transaction documents (illustratively promotions) are loaded via the webdriver 240 (block 245) to update the digital transaction documents (illustratively promotions) on the hosted PDD 200 (block 203). The webdriver 240 may pull the digital transaction documents (illustratively promotions) from the promotions server 230, or the promotions server 230 may push the digital transaction documents (illustratively promotions) to the webdriver 240, as desired. The shopper signs out when the transfer of new promotions to the hosted PDD 200 is completed (block 246).

FIG. 13 shows another illustrative implementation in which the host web browser 210 is used to access the profile server 220 for managing digital transaction documents, illustratively promotions, on a hosted PDD 200. A webdriver 260 is used which, like the webdriver 240 in the FIG. 12 implementation, has significant functionality but is still a relatively thin object. Unlike the FIG. 12 implementation, the FIG. 13 implementation provides the webdriver 240 browser-based plug-in object from the hosted PDD 200 to the host. In particular, a loader program in the hosted PDD 200 may install the browser-based plug-in object for the webdriver 260 on the host for the web browser operating on the host, from the hosted PDD. The FIG. 12 and FIG. 13 implementations may be combined, if desired.

As shown in FIG. 13, the shopper may insert the hosted PDD 200 into the host (block 204), whereupon a loader program detects if the webdriver 260 is missing and if so, installs the webdriver 260 browser-based plug-in (block 213). The webdriver 260 initiates contact with the profile server 220 (block 261) which then checks whether the installed webdriver is the current version (block 226). If necessary, the webdriver 260 is updated (block 262). The webdriver 260 next performs a credentials check for security purposes (block 263). The credentials may be contained in the user profile, which may reside on the profile server 220 (block 227) or alternatively, in encrypted form on the hosted PDD 200 (not shown). The webdriver 260 collects information from the hosted PDD 200 about the digital transaction documents (illustratively promotions) stored in device memory (blocks 264 and 206). The webdriver 260 provides the shopper with a management tool (bock 265) which enables the shopper to check the current content of the hosted PDD 200, to remove undesired and expired digital transaction documents (illustratively promotions), to explore what new promotion material is available, and to select new digital transaction documents (illustratively promotions). The webdriver 260 updates the user's profile (box 228) in accordance with the choices made by the shopper using the management tool 265, and a request is made for delivery of the digital transaction documents (illustratively promotions) in accordance with the update user's profile (box 233). The requested digital transaction documents (illustratively promotions) are loaded via the webdriver 260 (block 267) to update the digital transaction documents (illustratively promotions) on the hosted PDD 200 (block 207). The webdriver 260 may pull the digital transaction documents (illustratively promotions) from the promotions server 230, or the promotions server 230 may push the digital transaction documents (illustratively promotions) to the webdriver 260, as desired. The shopper signs out when the transfer of new promotions to the hosted PDD 200 is completed (block 268).

The various webdrivers (for example, 76, 86, 140, 160, 240 and 260) described herein are browser-based plug-in objects. While the webdriver may be implemented in a variety of different technologies, a particularly suitable technology is as a Java applet, which may be instantiated at the browser when the shopper visits a web site which supplies the object from profile server memory (for example, 70, 120 and 220) or other computer-readable medium, or which may be instantiated at the browser when a hosted personal digital device is connected to a host running the browser, the object being supplied either from profile server memory (or other computer-readable medium) or from memory of the hosted personal digital device by a loader program, or which may be instantiated at the browser when a browser is activated on a personal digital device, the object being supplied from memory or other computer-readable medium of the personal digital device. The webdriver preferably functions as a background process with runs in parallel with and is transparent to normal HTML and HTTP operations implemented by the client browser. The webdriver applet is implemented through appropriate Java classes, and may be persistent or transient as desired. If persistent, the webdriver applet persists in the browser disk cache, across different content pages within a site, across different web sites, and across successive browser sessions, thereby providing automatic updating of the hosted PDD whenever the device is plugged into the host.

The shopper profile maintained on the profile server in some implementations and on the personal digital device in other implementations contains information that is used to select digital transaction documents for the shopper. While the profile is to some extent established by the shopper, the profile may be augmented in various ways, including, for example, by third parties, preferably with the shopper's permission, and by automated agents based on the shopper's behavior and past choices.

Digital transaction documents may be provided from transaction document servers, or from a single server that consolidates digital transaction documents from many digital transaction document servers.

While the Internet 72 (FIG. 7) is a particularly useful network for providing digital transaction documents to personal digital devices, other types of networks may be used for communications between the profile server 70, the promotions server 71, the host 74 (FIG. 7), and the personal digital device 84 (FIG. 8), including a local area network (“LAN”), a wide area network (“WAN”), an intranet, an extranet, or other known network. The host 74 and the hosted PDD 78 communicate in any suitable manner, such as through wireless technology, cellular technology, phone line, dedicated service line (“DSL”), cable connection, or other known remote access technology. The profile server 70 and the promotions server 71 may be unitary or distributed.

While the techniques of FIGS. 10-13 are shown for hosted PDD's such as, for example, the hosted PDD 78 (FIG. 7), they are applicable to personal digital devices that are not hosted, such as, for example, the personal digital device 84 (FIG. 8), set top boxes, televisions with built-in internet access, and gaming consoles with internet access.

While the various examples of MoBeam key-type devices shown in FIG. 2 through FIG. 6 are particularly suitable for digital redemption for retail, other devices may also be used to enable digital transactions. Personal digital devices, for example, are digital devices that can be personalized for the user. They may be mobile, i.e. easily carried on the person, and include such devices as mobile phones, personal digital assistants (“PDA”), gaming devices, audio and video players, fobs, and USB Flash drives. They may be intended for use at a fixed location in a home, office or vehicle, and include such devices as external hard drives and set top boxes, including on-demand cable boxes. They may or may not include security features, and may or may not include the MoBeam technology. Personal digital devices may be suitable for many uses, including communications, entertainment, security, commerce, guidance, data storage and transfer, and so forth, and may be dedicated to a particular use or may be suitable for a combination of uses. These techniques described herein enable the large and growing population of personal digital devices to easily acquire digital transaction document content and, when suitably equipped, to use well established and widely adopted barcode standards to access the current commercial infrastructure, which is highly dependent on barcode scanners at points of sale. The same techniques may be used to access many other goods and services in addition to conventional commercial services.

The digital transaction documents may be stored on the personal digital device in any suitable type of memory. The personal digital device may include, for example, static or dynamic RAM (“SRAM” or “DRAM,” respectively) memory, FLASH memory, or any other type of memory.

Personal digital devices may be used to communicate information to a barcode scanner by light. These devices have light sources such as the device screen and LED's that may be driven by a simulated signal so that light from the light source simulates a reflection of a scanning beam being moved across a static visual image of the barcode.

Suitable light transmission techniques and various suitable types of personal digital devices are further described in U.S. Pat. No. 6,685,093 issued Feb. 3, 2004 to Challa et al.; U.S. Pat. No. 6,877,665 issued Apr. 12, 2005 to Challa et al.; U.S. Pat. No. 7,028,906 issued Apr. 18, 2006 to Challa et al.; U.S. Pat. No. 7,395,961 issued Jul. 8, 2008 to Challa et al.; and US Patent Application Publication No. US 2008/0035734, published Feb. 14, 2008 in the name of Challa et al., all of which hereby are incorporated herein in their entirety by reference thereto.

FIG. 14 shows a method of generating a signal for use with a sequential barcode scanner that simulates a barcode with light pulses. The method of FIG. 14 is particularly useful for sequential barcode scanners that use the reflection of a scanning beam being moved over a barcode. In block 300, digital transaction documents are acquired or generated, and stored in stored locally in memory of the personal digital device.

As shown in block 310, representative information for the digital transaction documents that identifies the digital transaction documents to a shopper of the personal digital device may be presented on an output facility of the device, if so equipped. The output facility may include, for example, a display such as an LCD screen of a PDA or wireless telephone, a speaker, or any other output device for communicating with a shopper. The representative information may include the transaction document itself, or may be other information that the shopper will associate with the transaction document. In order to identify the desired transaction document, the representative information for identifying the transaction document may be rendered, for example, in a textual, numerical, and/or graphical form and displayed on a screen of a suitably equipped personal digital device, or an audio, video or multimedia message that is played by a suitably equipped personal digital device. Promotions may be displayed on a screen of a mobile phone, for example, identifying the item and the terms of the promotional offer. In this manner, the shopper may conveniently identify the transaction document that is to be presented, is being presented, or has been presented to the barcode scanner. If the personal digital device lacks a screen or if the screen is too small, the representative information may be presented in other ways, such as by a spoken message or patterns of tones. Alternatively, the representative information need not be displayed.

As shown in block 320, a desired barcode type is identified. The barcode type may be any type of barcode known in the art, such as, but not limited to, a UPC, EAN, Interleaved 2 of 5, Code 93, Code 128, and Code 39, or specially designed barcode types.

As shown in block 330, the digital transaction documents are encoded into a barcode format for the identified barcode type. The barcode format may be represented, for example, by a binary array. In a typical single-dimensional barcode, for example, the smallest width of a bar or space element of a barcode may be designated as a single element of an array. If the barcode has a width of 256 dots or pixels, and the smallest element of the barcode has a width of 4 dots or pixels, for example, a binary array having sixty four array elements (e.g., a1, a2, . . . , a64) may be used to represent the barcode format. Each array element is assigned a value depending on whether that portion of the barcode is part of a bar or a space. A bar, for example, may be designated as having a value equal to one (e.g., a1=1), and a space maybe designated as having a value equal to zero (e.g., a32=0). The array may also alternatively be a two-dimensional array, such as a bit map, that may be easily displayed on a screen.

As shown in block 340, optionally the transaction documents may be displayed in static visual barcode form. In this manner, a personal digital device can provide a transaction document as a static visual barcode, which may be readable by CCD scanners and some types of sequential barcode scanners. Other visual information may be displayed as well, such as, for example, a visual image of a product corresponding to the transaction document.

As shown in block 350, a signal to simulate the reflection of a scanning beam being moved across a visual image of the barcode format of block 330 is generated from the barcode format. The simulated signal may be generated corresponding to an approximated or measured scanning rate. If the simulated signal is to be generated for a scanner such as a laser scanner that utilizes a scanning rate in the range of about 30 to about 60 scans per second, the simulated signal may be generated using a scan rate within that range of scan rates (e.g., about 45 scans per second). Other types of scanners such as supermarket scanners are much faster, scanning at a rate of about 3000 to about 6000 scans per second. The simulation signal should be generated using a scan rate within that range. Alternatively, the simulated signal may be generated using a variable scan rate that is swept throughout a range of scan rates. Alternatively, as described below with respect to an exemplary infrared transmitter/receiver pair, the scan rate of the scanning beam may be measured where a receiver is available to detect the scanning beam. In this case, once the scanning rate or rates are determined, the signal is generated in block 350 corresponding to this scan rate or rates.

As shown in block 360, the simulated signal is transmitted as light pulses. For purposes of the present description, the term “light” refers to visible light and infrared light spectra. The term “pulse” refers merely to a change in light level; the characteristics of the change, i.e. the specific waveform shape, are not critical. The light pulses may be generated in any visible or infrared wavelength desired by any light source known in the art, such as an LED, a laser, an infrared transmitter, a backlight of an LCD screen, or a light bulb.

Some personal digital devices have light sources that either are not capable of pulsing quickly enough, or the light sources are controlled by application program interfaces (“API”) that for any number of technical or business reasons cannot be modified to pulse the light source as necessary. Some types of personal digital devices may not have any light sources, even though they are capable of receiving or storing information of a type that could usefully be communicated to a barcode scanner. These types of personal digital devices may be enabled for to communicate information to a barcode scanner by light using an accessory as described in US Patent Application US 2008/0128505, published Jun. 5, 2008 in the name of Challa et al., which hereby is incorporated herein in its entirety by reference thereto.

The promotions server shown in FIG. 7 (promotions server 71), FIGS. 10 and 11 (promotions server 130), and FIGS. 12 and 13 (promotions server 230) represent either a single server model or a many server model. A single server model is appropriate for a large retailer with house branding, while a many server model is appropriate for retailers that handle a variety of different brands of products.

The various embodiments of the invention described herein are illustrative. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention, as set forth in the following claims.

1. A method for loading digital transaction documents to a personal digital device, comprising:
running a web browser;
instantiating a browser-based plug-in object in the web browser for:
receiving from over a network a plurality of digital transaction documents; and
loading the digital transaction documents received in the receiving step to a memory of the personal digital device; and
communicating at least one of the digital transaction documents from the memory of the personal digital device to enable a digital transaction.

2. The method of claim 1 wherein:
the personal digital device comprises a light communication system; and
the communicating step comprises communicating at least one of the digital transaction documents from the memory of the personal digital device to a bar code scanner as a simulation of a reflection of a scanning beam being moved across a static visual image of a barcode representative of the selected digital transaction document,

3. The method of claim 2 wherein:
the digital transaction documents compromise promotions; and
the communicating step is performed at a point-of-sale.

4. The method of claim 1 wherein the communicating step comprises communicating at least one of the digital transaction documents from the memory of the personal digital device to a server networked to the network.

5. The method of claim 1 wherein the receiving step comprises pulling the digital transaction documents from a server networked to the network.

6. The method of claim 1 wherein the digital transaction documents in the receiving step are pushed to the browser-based plug-in object from a server networked to the network.

7. The method of claim 1 wherein the web browser running step comprises running the web browser on a host, the personal digital device being removably connected to the host, and the host being networked to the network.

8. The method of claim 7 further comprising receiving the browser-based plug-in object for the instantiating step on the host from a server networked to the network.

9. The method of claim 7 further comprising receiving the browser-based plug-in object for the instantiating step on the host from the personal digital device.

10. The method of claim 1 wherein the web browser running step comprises running the web browser on the personal digital device, the personal digital device being networked to the network.

11. The method of claim 10 further comprising receiving the browser-based plug-in object for the instantiating step on the personal digital device from a server networked to the network.

12. The method of claim 1 further comprising:
maintaining a user profile;
selecting the digital transaction documents in accordance with the user profile; and
delivering the selected digital transaction documents to the network for the receiving step.

13. The method of claim 12 wherein the delivering step comprises pulling the selected digital transaction documents from the network.

14. The method of claim 12 wherein the delivering step comprises pushing the selected digital transaction documents to the network.

15. The method of claim 12 wherein:
the maintaining step is performed by a profile server networked to the web browser over the network; and
the selecting step is performed by a digital transactions server networked to the web browser over the network.

16. The method of claim 12 wherein the maintaining step and the selecting step are performed by the browser-based plug-in object.

17. A method for loading digital transaction documents to a personal digital device connected to a host, comprising:
accessing from the host a user profile on a profile server, the host being networked to the profile server over a network;
instantiating a browser-based plug-in object in a web browser running on the host;
removably connecting the personal digital device to the host with a wired or wireless connector, the personal digital device comprising;
a memory for storing the digital transaction documents;
a pulsed light barcode presentation system for communicating at least a selected one of the digital transaction documents from the memory; and
a wired or wireless connector for connecting the personal electronic device to the host to load the digital transaction documents into the memory; and
loading digital transaction documents based on the user profile to the memory of the personal digital device, the digital transaction documents being pushed to the personal digital device via the network and the browser-based plug-in object, wherein the browser-based plug-in object operates independently of the browser and transparently to a user of the host.

18. A mobile personal digital device comprising:
a processor;
a memory associated with the processor;
a network communications system controlled by the processor;
a web browser computer program element; and
a browser-based plug-in object for:
receiving with the network communications system from over a network a plurality of digital transaction documents; and
loading the digital transaction documents received in the receiving step to the memory; and
a computer program element for communicating at least one of the digital transaction documents from the memory of the personal digital device to enable a digital transaction.

19. The mobile personal digital device of claim 18 further comprising a pulsed light barcode presentation system, for communicating at least a selected one of the digital transaction documents from the memory under program control of the communicating computer program element.

20. A computer-readable medium encoded with a browser-based plug-in object comprising attributes and behaviors for:
receiving from over a network a plurality of digital transaction documents; and
loading the digital transaction documents received in the receiving step to a memory of the personal digital device.
